(19) United States
(12) Patent Application Publication
(10) Pub. No.: US 2014/0141134 A1
(43) Pub. Date: May 22, 2014

(54) SYSTEMS AND METHODS FOR CREATING A CUSTOMIZED BLEND OF PET FOOD

(71) Applicants: Keith D. Johnson, Cincinnati, OH (US); Susan Liew Giovengo, West Chester, OH (US)

(72) Inventors: Keith D. Johnson, Cincinnati, OH (US); Susan Liew Giovengo, West Chester, OH (US)

(21) Appl. No.: 14/084,434

(22) Filed: Nov. 19, 2013

Related U.S. Application Data
(60) Provisional application No. 61/728,070, filed on Nov. 19, 2012.

(51) Int. Cl. A23K 1/00

(52) U.S. Cl. CPC A23K 1/001
USPC 426/231

(57) ABSTRACT

Disclosed are embodiments of a method for providing a customized food blend for a pet, the method comprising creating a first environmental profile for the pet at a first time with a customized kibble blending system, creating a nutritional target for the pet, creating a pre-blend database, providing a plurality of pre-blends, determining a custom blend, and blending a custom blend for the pet.

### REFERENCE TO RELATED APPLICATION

The present application claims the priority benefit of U.S. provisional patent application Ser. No. 61/728,070, filed Nov. 19, 2012, and hereby incorporates the same application herein by reference in its entirety.

### TECHNICAL FIELD

Embodiments of the technology relate, in general, to customizing pet food, and in particular to customizing pet food blends based on a variety of inputs and calculations.

### BACKGROUND

Pet owners often want the very best for their pet and generally treat that pet as a member of the family. Owners often rely on what is in stores to provide for their pet's nutritional needs. Because of limited shelf space, the inherent high bulk of pet food, and a plethora of brands, there is only space for a limited selection for each brand. Brands may have a few different ingredient varieties to choose from, such as puppy, maintenance, and senior formulas, but often little else is offered. The permutations for each brand are limited by the available shelf space, which limits the number of available options for a pet owner. Most owners, however, would like to have a diet that is designed for their individual pet the same way a meal might be designed for a family member with particular dietary needs or preferences. With existing systems, such customization is not possible at a low cost because of the economies of scale of pet food production and manufacture.

### BRIEF DESCRIPTION OF THE DRAWINGS

The present disclosure will be more readily understood from a detailed description of some example embodiments taken in conjunction with the following figures:

FIG. 1 depicts a schematic view of an example customized kibble blending system according to one embodiment.

FIG. 2 depicts a flow chart of an example method for providing a customized pet food blend according to one embodiment.

FIG. 3 depicts a more detailed flow chart of the step of creating an environmental profile as shown in FIG. 2, according to one embodiment.

FIG. 4 depicts a more detailed flow chart of the step of creating a profile database as shown in FIG. 2, according to one embodiment.

FIG. 5 depicts a more detailed flow chart of the step of creating a nutritional target as shown in FIG. 2, according to one embodiment.

FIG. 6 depicts a more detailed flow chart of the step of determining a custom blend as shown in FIG. 2, according to one embodiment.

FIG. 7 depicts a more detailed flow chart of the step of providing a plurality of pre-blends as shown in FIG. 2, according to one embodiment.

FIG. 8 depicts a more detailed flow chart of the step of blending a custom blend as shown in FIG. 2, according to one embodiment.

FIG. 9 shows an example screenshot illustrating various aspects of the input for a customized kibble blending system according to one embodiment.

FIG. 10 shows an example screenshot illustrating various aspects of the output for a customized kibble blending system according to one embodiment

### SUMMARY

Disclosed are embodiments of a method for providing a customized food blend for a pet, where the method can include creating a first environmental profile for the pet at a first time with a customized kibble blending system, creating a nutritional target for the pet, creating a pre-blend database, providing a plurality of pre-blends, determining a custom blend, and blending a custom blend for the pet.

Disclosed are embodiments of a method for providing a customized food blend for a pet, where the method can include creating a first environmental profile for the pet at a first time with a customized kibble blend system, the customized kibble blending system including a custom blending computer system, where creating the first environmental profile comprises inputting pet characteristics, where the pet characteristics can include age, breed, and weight, inputting home characteristics, inputting food preferences, inputting shopping characteristics, inputting relationship characteristics, and inputting a daily diet for the pet. The method can include creating a custom nutritional target for the pet, where creating the custom nutritional target for the pet comprises providing the first environmental profile, acquiring data, where the data can include published pet nutrition information, comparing the data to the first environmental profile, and generating the nutritional target from the data and the first environmental profile. The method can include creating a pre-blend database, providing a plurality of pre-blends, determining a custom blend, and blending the custom blend for the pet, where blending the custom blend for the pet comprises providing the nutritional target, comparing the pre-blend database to the nutritional target, selecting a plurality of pre-blends from the pre-blend database, determining the amount and ratio of each of the selected plurality of pre-blends, and blending the plurality of pre-blends. The method can include packaging the blend with a custom package and shipping the custom package.

Disclosed are embodiments of a method for providing a customized food blend for a pet, where the method can include a step for creating an environmental profile, a step for creating a nutritional target, a step for creating a pre-blend database, and a step for creating a custom blend from the pre-blend database.

### DETAILED DESCRIPTION

Various non-limiting embodiments of the present disclosure will now be described to provide an overall understanding of the principles of the structure, function, and use of the proficiency tracking systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of computer-based systems and methods for customizing kibble blends for animals such as pets. In one example embodiment, information about an animal, information about an animal's environment, published data, and historical data about the animal can be used to determine a nutrition target. In some embodiments, a nutrition target can be compared against available kibble pre-blends to create a customized blend. In some embodiments, the customized blend recipe can automatically be sent to a fulfillment center that can blend and ship a customized blend to a customer.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can allow consumers to more effectively treat their pet as part of the family. Systems and methods described herein can provide a diet that is specifically designed for an individual pet in the same way a parent might design a meal for their family. Systems and methods described herein can include a plurality of components, a plurality of pre-blends, and a plurality of blends customized for an individual pet in near real time. Systems and methods described herein can provide customized pet diets cost effectively. Embodiments of the systems and methods described herein can be automated to efficiently monitor, blend, package, and deliver a customized kibble blend or product.

A blend customization computer system can execute software for selecting, providing, creating, manufacturing, or shipping an optimized blend of pet kibble, as described in more detail below. Kibble can include any food product, component, blend, pre-blend, coating, supplement, vitamin, grain, meat, mixture, or suitable combination. The blend customization computer system can run on any suitable computing system, such as a dedicated server, a user computer or server, multiple computers, a collection of networked computers, a cloud-based computer system, a web-based computer system, or from a storage device, for example. One or multiple processing units, such as central processing units and/or graphics processing units, may perform instructions stored in memory to execute the processes described herein.

A blend customization computer system in accordance with the present disclosure can be accessed via any suitable technique, such as a web-browser such as SAFARI, OPERA, GOOGLE CHROME, INTERNET EXPLORER, or the like executing on a client device. In some embodiments, the systems and methods described herein can be a web-based application or a stand-alone executable. Additionally, in some embodiments, the systems and methods described herein can integrate with various types of blending systems, customization systems, fulfillment systems, shipping systems, databases, e-commerce systems, data acquisition systems, veterinarian systems, social networks, and the like. Any suitable client device can be used to access, and/or execute, the blend customization computing system, such as laptop computers, desktop computers, smart phones, tablet computers, gaming system, and the like.

Systems and methods described herein may generally provide a customized environment for users (e.g., a pet profile) to identify and address a specific pet's health and dietary needs. Interaction with the blend customization computer system may include, without limitation, keyboard entry, writing from pen, stylus, finger, transmitters, receivers, or the like, with a computer mouse, or other forms of input (voice recognition, etc.). The blend customization computer system may be presented on a tablet, desktop, phone, board, or paper. In one embodiment, the user may interact with a customized interface by writing with a smart pen on normal paper, modified paper, or a hard flat surface of their preference. In this embodiment, the user may receive real-time feedback, or at least near real-time feedback, or may synchronize with a blend customization computer system at a later date. The blend customization computer system can be a personal computer, one, or multiple computers in a server-type system.

User interaction with the blend customization computer system may take place in any of a variety of operational environments, such as a work setting or a home setting, with one or more users interacting with the system at a given time.

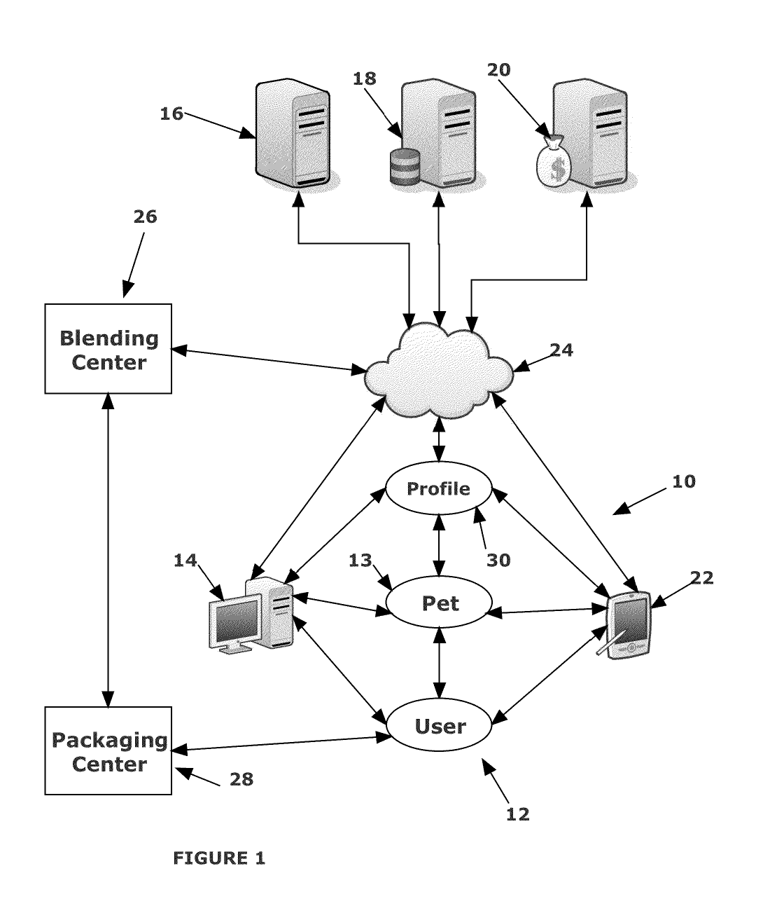

Referring now to FIG. 1, disclosed is one embodiment of a customized kibble blending system 10. The customized kibble blending system 10 can be configured to blend or otherwise produce, mix, package, suggest, or manufacture any suitable kibble, including kibble for pet food, where the blended kibble can be packaged and/or shipped to a consumer, pet parent, or user 12. The customized kibble blending system 10 can include any suitable network of peripheral data or component connections and can include the blend customization computer system. For example, the customized kibble blending system 10 can be coupled with a computing device such as a personal computer 14 or smartphone 22, such that a user 12 can communicate with or control the customized kibble blending system 10 and/or create a profile 30. Communication can be wired or wireless and can include short-range wireless interconnection of cellular phones, computers, and other electronic devices, wired USB, flash drive, or any other suitable connection. It will appreciated that communication with the customized kibble blending system 10 can be two-way, where the customized kibble blending system 10 can push or otherwise transmit any suitable data, notifications, or the like to any suitable component or peripheral device. Such data or commands can include choosing a recipe, adjusting recipe parameters, determining when a package will be shipped, or the like. The customized kibble blending system 10 can include a pet 13, where the pet 13 can carry a transmitter and/or receiver, sensor, skin patch, body harness, injectable chip, pedometer, or the like, that can be configured to send and/or receive information in communication with any suitable device or source. Other sensors or monitors, such as food bowl sensors, pet feeding stations, weight sensing mats, water intake monitors, skin moisture monitors, saliva monitors, body fluid monitors, or the like are contemplated. Data can also be transmitted or received from a local area network, a cloud 24, or from any other suitable source. It will be appreciated that the personal computer 14, smartphone 22, or any other suitable peripheral device or data can be associated with the manufacturer or operator of the customized kibble blending system 10, where data can be sent through the cloud 24 to a user 12 regarding customized kibble blending system 10. Such communications can include new product offerings, new recipes, personalized messages, requests for information, or the like. It will be appreciated that pet 13 is shown by way of example only, where systems and methods described herein can be applied to any animal, such as farm animals, working animals, food animals, fish, reptiles, rabbits, gerbils, or the like. A user 12 can be any person, including a person that cares for an animal, such as a pet. The user 12 can include a pet caretaker, where the pet caretaker can, for example, carry a transmitter and/or receiver, sensor, pedometer, or the like, that can be configured to send and/or receive information in communication with any suitable device or source. It will be appreciated that user 12 can include a plurality of individuals that can communicate information to the customized kibble blending system 10.

The customized kibble blending system 10 can be coupled with or communicate via the cloud 24 with a server 16, a database server 18, or an ecommerce server 20. It will be appreciated that server 16 can communicate, store, or process any suitable data or information related to the customized kibble blending system 10. The database server 18 can maintain any suitable information or data related to the customized kibble blending system 10 including, for example, a population database for users, a population database for pets or animals, a breed database, a nutrient database, an environmental data database, a pre-blend database, a blend database, a component database, a process database, a consumer preference database, geographic maps of disease risk and incidence, regional weather and temperature, urban and rural comparative information, or the like. The customized kibble blending system 10 can be coupled with the ecommerce server 20, or any other suitable ecommerce platform, where purchases can be made automatically or manually. For example, the ecommerce server 20 can maintain user 12 financial information, such as credit card information, and can automatically determine when a user's supply of pet kibble is below a threshold and automatically order additional pet kibble based upon the user 12 preferences that can stored in the database server 18. It will be appreciated that any suitable storage device retaining any suitable information, such as recipes, pre-blends, blends, or personal preferences, can be coupled or can be integral with the customized kibble blending system 10. It will be appreciated that data can be transmitted to, received from, and stored within the cloud 24, or otherwise suitably stored or transmitted.

The customized kibble blending system 10 can be connected to the internet and can upload and download information to/from computer servers, such as servers 16, 18, 20, that can be attached to the internet. These servers can be owned and maintained by a company selling the customized kibble blending system 10, which can provide consumers with a variety of functions. A website can also be associated with the customized kibble blending system 10 that can have information to educate the consumer about the kibble and the health benefits or customization of a particular batch or blend of kibble. This information can include detailed nutrition information, user generated feedback, information about a pet 13, information about the progress of a pet 13, owner and pet 13 home environment and lifestyle, or the like. The website can allow for tracking packages, can verify the packaging for authenticity, or can include any other suitable information.

The customized kibble blending system 10 can include a profile 30. Such profile 30 can be an environmental profile processed by the server 16 and stored on the database server 18. The profile 30 can be processed by the server 16 such that a customized or optimized blend of kibble can be created by a blending center 26. An accurate profile 30 for a pet, user, and general environment can help accurately identify the specific dietary needs for a pet 13. The profile 30 can include a plurality of inputs from the user 12, the pet 13, the servers 16, 18, 20, or any other suitable information. Such information can be transmitted directly to the server 16, or can be entered into a website or the like via a personal computer 14 or smartphone 22. As will be described in more detail herein, the profile 30 can include pet characteristics, which can be monitored directly from the pet 13 by a sensor, or the like, and transmitted to the profile 30. Such monitored characteristics can include heart rate, blood oxygenation saturation, metabolism-related characteristics, carbon dioxide levels, distance traveled, steps taken, eating cycles, sleep cycles, defecation and urination cycles, body fluids measurements, saliva measurements, skin moisture measurements, exudates, body condition, muscle condition, gait changes, activity level, daily activity patterns, or other biometric, physical, or mental characteristics. Pet characteristics can include information about the pet 13 that can be input by the user 12 into the personal computer 14 or smartphone 22, for example, including age, weight, breed, breed mix, life stage, body condition score, special diet needs, small, medium, or large breed size, puppy or adult, clinical history from a user 12 veterinarian, registration information from breeders, veterinary records, licensing body records, breeder information, a pet travel passport, shot records, or the like. Breed information may be helpful for a variety of reasons as an animal's breed, such as dog breed, can have a significant impact on nutrition. The breed information can be associated with particular dietary needs, with particular medical conditions, with particular exercise needs, or the like. In addition, breed information can help inform how fast an animal will grow and how an animal may age. For example the customized kibble blending system 10 can make time-based adjustments to the profile 30, where a fast growing breed can result in a larger suggested amount of food with a different nutritional profile then a slower growing breed.

The profile 30 can also include information about home characteristics. These home characteristics can be monitored or can be input by a user 12. Monitored characteristics can include carbon dioxide levels, light levels, elevation, chemical exposure, such as carpet cleaner, lawn treatments, or flea prevention products, or the like. Input information can include home square footage, weather conditions, region, elevation, climate, number of children, age of children, other pets, other types of pets, time spent outdoors, or the like. The home characteristics can also include a GPS location for the pet 13 or owner 12, where the profile 30 can be associated with geo-fencing applications. For example, a user 12 can indicate that the would like to be notified via the smartphone 22 when they come within a certain distance from a dog park. Coupons and other offers can also be provided. The profile 30 can include user 12 and pet 13 food preferences, where the food preferences can be entered by the user 12 into the personal computer 14 or smartphone 22, for example. Food preferences may include dietary restrictions or preferred foods where vegetarian options, meat preferences, allergies, grain preferences, corn preferences, fat content preferences, carbohydrate content preferences, and tastes can be addressed and selected.

The profile 30 can also include other dietary considerations, such as other food that is being fed to a pet. Pet owners will often feed their pets treats, include additive products with the pet's kibble, or otherwise modify the pet's diet beyond the basic kibble. The profile 30 can include an interface into which information related to a pet's daily consumption can be entered. A user 12 can, for example, input a daily log of a pet's diet, including vitamins or dietary supplements, into the customized kibble blending system 10, where the information can be used to create a complete profile 30. The database 18 can include a database of pet foods and pet products, where items may be searchable and selectable from this database. For example, if a user 12 feeds their pet 13 a particular treat, the user 12 can look up this treat in the database 18, select the treat, and the nutritional information related to this treat can automatically be added to the profile 30. It will be appreciated that the profile 30 can include a running record of the diet of a pet 13, where this information can be used to calculate an optimized blend. Such a profile can also be used to encourage behavior, such as exercise, for pets that may be experience a weight or health condition. Such a profile can include a gamification component such that, for example, a veterinarian can reward a user 12 for keeping their pet 13 within a predetermined caloric intake for the day.

The profile 30 can also include relationship characteristics and a relationship profile. The relationship characteristics can include whether the pet is a service pet, whether the animal is primarily a family pet, whether the animal also performs work duties such as farm duty, search & rescue, drug detection, military, guard, therapy pet, or the like.

The profile 30 can include information related to the shopping profile for a user 12. For example, the shopping profile can include information stored on the e-commerce server 20 including billing information and credit card information. The shopping profile can also include billing preferences, payment preferences, shipping preferences, shipping frequency preferences, user 12 personal information, shipping size preferences, coupon information, rewards information, affinity program information, co-branding information, opt-in information, life stage milestones, health triggers, or the like.

Information regarding a user 12 and a pet 13, such as the profile 30, dietary needs, health history, veterinarian input, optimal nutrition target, and/or other suitable information can be processed by the server 16 to determine a suitable blend of kibble for the pet 13. This information or data regarding a blend or recipe can be transmitted to a blending center 26. The blending center 26 can house the customized kibble blending system 10, or can be an offsite blending or production facility. In one embodiment, the blending center 26 can create and/or store a plurality of pre-blends that can be blended into a final product. The pre-blends can be configured from any suitable ingredients or kibble products and can be created at the blending center 26 or can be acquired by the blending center 26. The blending center 26 can receive information regarding an optimized or customized pet recipe and can then automatically or manually blend a desired amount of kibble from the plurality of pre-blends to create the blend specified by the recipe. For example, the customized blend recipe may call for a first percentage of a first pre-blend, a second percentage of a second pre-blend, and a third percentage of a third pre-blend, to create a customized blend of kibble weighing a specified amount, where the customized blend of kibble can match a nutrition target for the pet 13. The user 12 may choose to experiment with process parameters to suit individual pet 13 or user 12 tastes. The user 12 can decide to upload their personal recipe for a specific kibble to the website for free access by all, or may choose to upload the recipe and charge others for access. The website can handle the transaction and can take a percentage of the sale price for facilitating the transaction. Chefs, veterinarians, or celebrities can create branded recipes specific to a particular pet breed or pet condition.

It will be appreciated that the profile 30 can include any suitable checks and balances or feedback to maintain accuracy or otherwise perform elements of the system. Any aspect or element of the system can be performed manually or automatically. For example, the customized kibble blending system 10 can monitor user 12 inputs for a breed and can approve a custom blend so long as the nutrition is within a pre-determined threshold for one or a plurality of characteristics. If the customized kibble blending system 10 indicates that such a characteristic is outside of the range, the profile 30 can be flagged for manual review.

Containers, pods, packages, or any other suitable kibble retainer can be packaged at a packaging center 28 and shipped to a user 12. The packages can be shipped or sold with optimized and/or customized recipes encoded on the packages such that a package can be scanned to determine the optimized pet blend. The user 12 can be a pet owner, a veterinarian, or a boutique pet food provider that can sell customized food under a white label. As will be described herein, the packaging and other containers can be customized to the needs of the owner or pet.

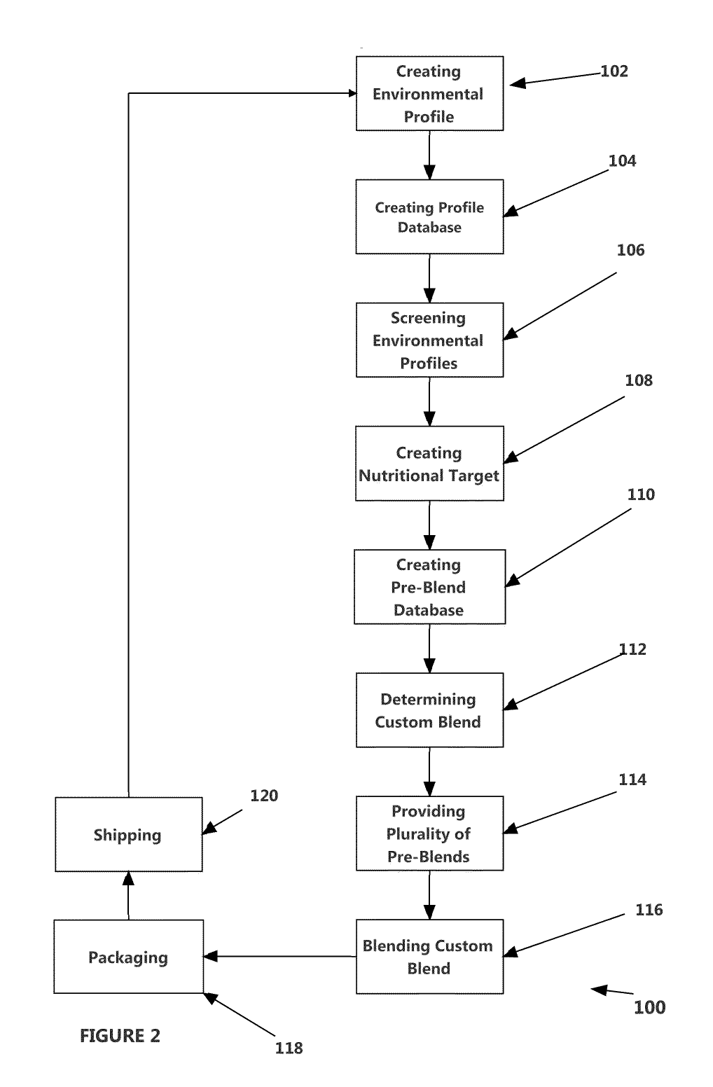

FIG. 2 illustrates one version of a method 100 for blending, packaging, and shipping a custom blended pet food to a customer. It may be beneficial to provide a customized food blend that is directed to the health and nutritional requirements of an individual pet. Methods can include obtaining environmental information about a pet, processing the information with the customized kibble blending system 10, and blending a customized pet food from a plurality of pre-blends to create an optimized diet. Method 100 can improve the cost effectiveness of providing a customize food product, kibble, or the like, for a pet or other animal. It may be cost prohibitive to provide a custom food from scratch, for example, where it may be more cost effective to provide a plurality of pre-blends associated with detailed nutrition information that can be blended to cost effectively match a pet's nutrition target. Such a system and method may also be more rapidly completed as the pre-blends may be blended efficiently to create a custom blend.

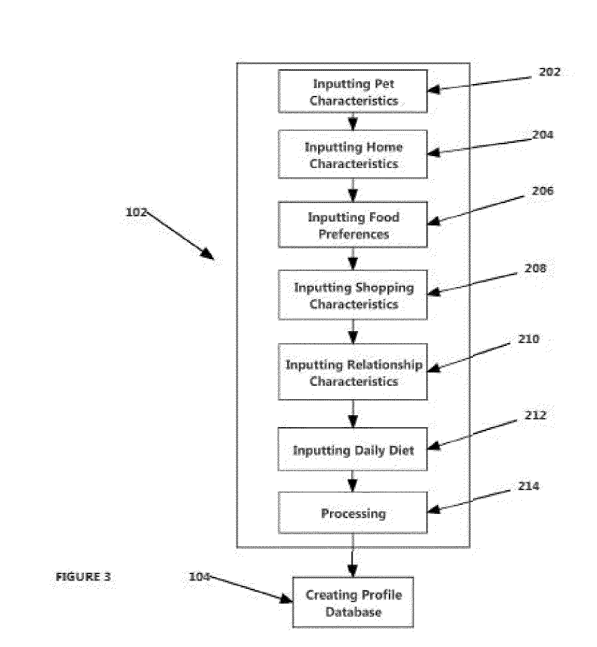

The method 100 can include Creating an Environmental Profile 102, which can include creating a profile 30 in accordance with versions described herein. The profile 30 can be created using passive and/or active inputs from a user 12, a pet 13, a veterinarian, from sensors or monitors, from published data, from available databases, or from any suitable source as described above. Referring to FIG. 3, Creating an Environmental Profile 102 can include Inputting Pet Characteristics 202, such as species, breed, age, gender, weight, and additional genetic and health information, Inputting Home Characteristics 204, Inputting Food Preferences 206, Inputting Shopping Characteristics 208 for a user 12, Inputting Relationship Characteristics 210, and Inputting Daily Diet 212. In this manner, a comprehensive profile 30 can be created in processing 214 for both a user 12 and a pet 13 that includes any and all factors relevant to a pet's diet and nutrition. It will be appreciated that the step of Creating an Environmental Profile 102 can include creating a dynamic profile 30, where the server 16 of the customized kibble blending system 10 can be using all available data to create a real time or near real time profile 30. Pet Characteristics 202 can also include a body condition score, which can include an assessment of the animal's weight for age and weight for height ratios, and its relative proportions of muscle and fat. The assessment can be made by eye, on the basis of amount of tissue cover between the points of the hip, over the transverse processes of the lumbar vertebrae, the cover over the ribs and the pin bones below the tail, for example. Each animal can be graded by comparison with animals pictured on a chart from one to eight, for example, where the comparison can be made by a user 12 such as a pet owner, a veterinarian, or the like.

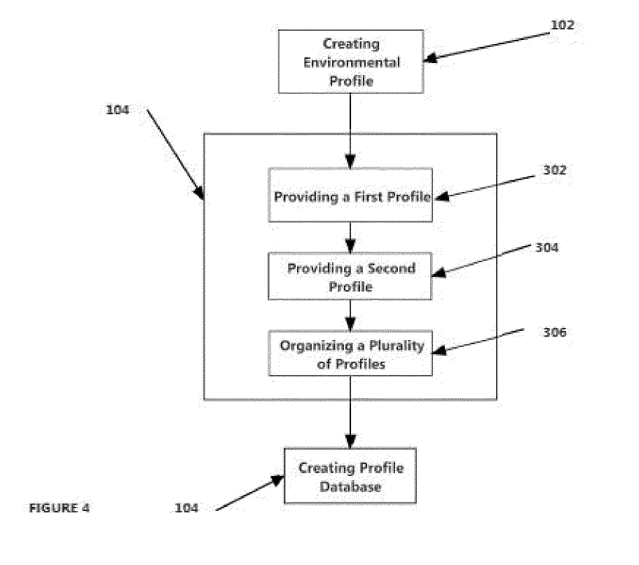

Method 100 can include Creating a Profile Database 104, which can include aggregating a plurality of profiles 30 associated with a plurality of users 12 and pets 13. It may be beneficial to gather all available information related to a plurality of users 12 and pets 13, in addition to other profile 30 information, such that the customized kibble blending system 10 can become more accurate regarding blend suggestions. Referring to FIG. 4, the step of Creating a Profile Database 104 can include Providing a First Profile 302, Providing a Second Profile 304, and Organizing a Plurality of Profiles 306. Providing a First Profile 302 can include providing a profile 30 from a first user 12 and a first pet 13. Providing a Second Profile 304 can include providing a profile 30 from a second user 12 and a second pet 13. Organizing a Plurality of Profiles 306 can include storing the plurality of profiles in a database 18 and sorting and organizing the profiles by any suitable factor or characteristic. Maintaining such data may be beneficial to studies and other academic pursuits, where specific conditions can be tracked and evaluated. Creating a Profile Database 104 can include aggregating a plurality of profiles 30, however it will be appreciated that the customized kibble blending system 10 can aggregate any suitable profile from any suitable location in accordance with versions described herein.

Method 100 can include Screening Environmental Profile 106, which can include allowing a user 12 to actively help maximize the accuracy of a profile 30. Many pets 13 are not pure breeds and, in many cases, a user 12 may be unaware as to what mix of breeds their pet may be. There may also be cases where a pet 13 is a pure breed, but a user 12 may have input the incorrect breed type. In an example embodiment, the customized kibble blending system 10 can include a user interface that can prompt a user 12 with a series of questions to improve the accuracy of a profile 30. For example, if a user has input a particular breed for their pet, the system 10 can generate a photo from the database 18 to display to the user 12. The user 12 can then confirm that their pet 13 does resemble the image shown. If the image does not resemble the pet 13 of the user 12, the user 12 can be taken through a pre-programmed set of questions that can help identify a particular breed. In an alternate embodiment, the system 10 can help identify the breed lineage in a mixed breed. A series of questions can be asked, and photos of various breeds can be shown, to help identify a particular mixed breed. Photos of mixed breeds can also be included in the database 18 to display as examples. Such information can be communicated to a veterinarian for further confirmation regarding breed type. Many pet are prone to breed-specific health conditions and needs, where such a system may help identify specific needs even in mixed breeds.

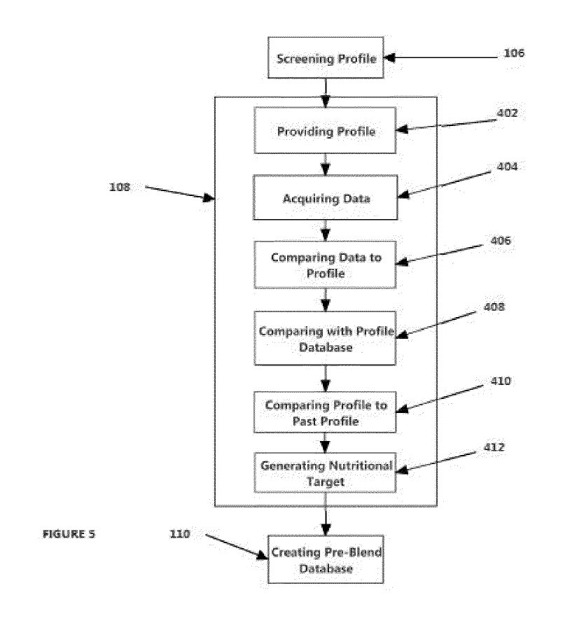

Method 100 can include Creating a Nutritional Target 108 for a pet 13. Creating a Nutritional Target 108 can include determining an optimal nutrient blend for a pet 13 based upon their profile 30. Including a large number of characteristics, from a variety of categories, can help identify a target nutrient balance for a pet 13. A nutritional target, which can include specific percentages of vitamins, proteins, carbohydrates, lipids, anti-oxidants, minerals, fiber, or the like, can provide a baseline goal for a customized kibble blend. Referring to FIG. 5, Creating a Nutritional Target 108 can include Providing an Environmental Profile 402 for a pet 13, which can include providing the profile 30 to the server 16 (FIG. 1). Next, the customized kibble blending system 10 can transition to the step of Acquiring Data 404, where data can be sourced from third parties, from published databases, or internally from the database server 18. Acquiring Data 404 can include collecting published nutrition data, AAFCO nutritional guidelines, textbooks, food safety guidelines, FDA guidelines, life stage-specific needs from nutritional references, collecting breed-specific information, collecting profile 30 information from other pets 13, collecting veterinary data and published veterinary guidelines, or any other data relevant to animal care.

Creating a Nutritional Target 108 can include Comparing Data to Profile 406, which can include comparing the data or information from the step of Acquiring Data 404 to a pet's profile 30. This analysis can be performed, for example, by the server 16 of the customized kibble blending system 10. The analysis can, for example, compare the profile 13 of the specific pet 13 against all available and recent data to determine the nutritional target for the pet 13. For example, using only a few characteristics, such as breed, weight, and age, may not provide enough information such that an optimized nutritional target can be created. For example, it is generally believed that spaying or neutering an animal can have a significant impact on dietary needs, where the step of Comparing Data to Profile 406 can account for this information and any other suitable information from the profile 30. The step of Comparing Data with Profile Database 408 can then compare the profile 30 for an individual pet 13 against the other profiles in the database server 18. Such a comparison can evaluate progress made by similarly situated pets, for example, in providing an optimized nutritional target and dietary plan.

Creating a Nutritional Target 108 can include Comparing Profile to Past Profile 410. It will be appreciated that the profile 30 for a pet 13 can be a constantly changing picture of the pet 13. Characteristics such as age and weight will constantly be changing and the profile 30 for a pet 13 can be dynamic to capture these changes in real time or near real time. Prior to generating a nutritional target, the customized kibble blending system 10 can compare the profile 30 for a pet 13 at a first time to the profile 30 for the same pet 13 at a second time, where the second time can be a profile 30 recorded prior to the first time. Step 410 can include comparing a current profile 30 to a plurality of past profiles for the same pet to ascertain patterns, trends, successes, or other relevant information. Based on this comparison, and the comparison to published data and stored data regarding similarly situated pets, the customized kibble blending system 10 can then transition to the step of Generating a Nutritional Target 412. As described herein, the nutritional target can include a detailed and highly granular target that can target a pet's or animal's dietary needs.

The method 100 can include the step of Creating a Pre-Blend Database 110, where any suitable number of data regarding pre-blends, pre-mixes, blends, or components can be stored, for example, in the database server 18. This can include storing the pre-blend, the name of the pre-blend, and all nutritional information related to the pre-blend. The database server 18 can, for example, retain hundreds, thousands, or any suitable number of listed pre-blends, pre-mixes, or the like, including associated information. The data associated with the pre-blend database can be retained within the database server 18 or can be stored or accessed from any suitable location including from a variety of locations that can each source a number of pre-blends or pre-mixes. Step 110 can also include generating a plurality of desirable pre-blend recipes where, for example, the server 16 can access the database server 18, or any other suitable information including a breed database, a nutrient database, an environmental database, a component database, or the like, to provide suggested pre-blends. In one version, the customized kibble blending system 10 can aggregate and store existing kibble pre-blends, can determine if any nutritional gaps are present in the available pre-blends, and can suggest recipes to address specific nutrient needs.

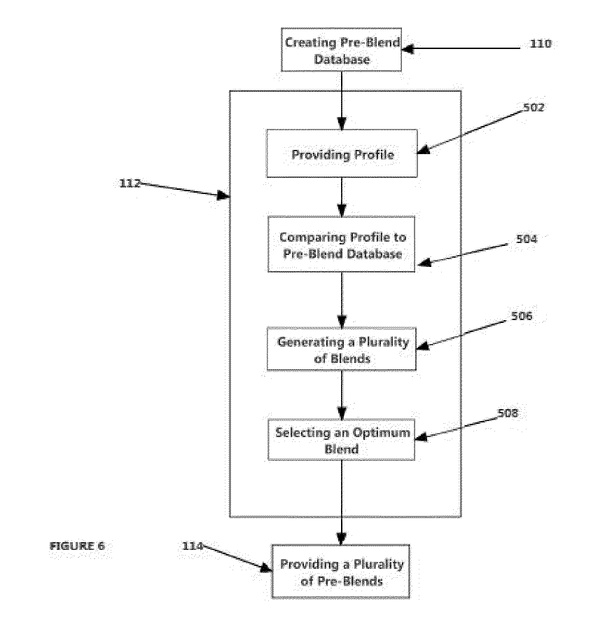

The method 100 can include the step of Determining a Custom Blend 112 for a pet 13. The step of Determining a Custom Blend 112 can include, with reference to FIG. 6, the step of Providing a Profile 502, which can include the server 16 retrieving information about the profile 30 for a pet 13. The step 112 can include Comparing Profile to Pre-Blend Database 504, which can include comparing the profile 30 of a pet 13 to the available pre-blends in the pre-blend database, which can be stored on database server 18. The server 16 can create one or more suggested blends, including type and percentage of pre-blend that meet closely or exactly match the nutritional target for the pet 13. The server 16 can then move to the step of Generating a Plurality of Blends 506, which can including generating one or a plurality of suggested blends of the available pre-blends to match the nutritional target. The step 112 can also include Selecting an Optimum Blend 508, where a single blend can be selected from a plurality of blend options presented by the server 16. The optimum blend can be selected by the user 12 based on preferences, can be selected by the customized kibble blending system based upon cost, can be selected based upon profile 30 preferences, can be selected based upon pre-blend availability, or can otherwise be selected.

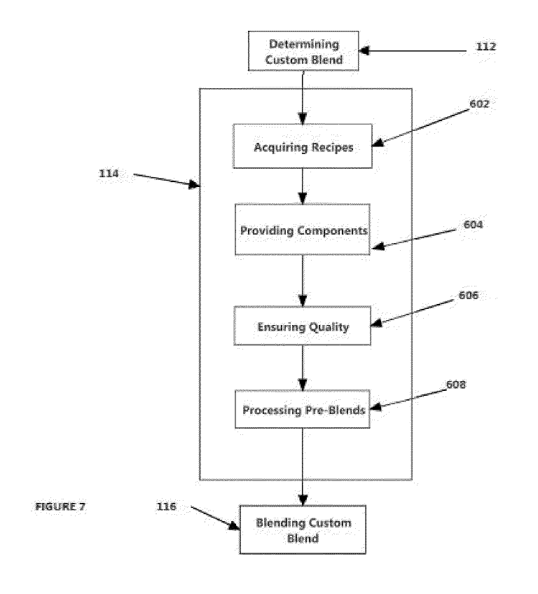

The method 100 can include the step of Providing a Plurality of Pre-Blends 114, as shown in FIG. 7. Information regarding pre-blends and pre-blend recipes can be created or aggregated in accordance with step 110, where step 114 can include creating physical pre-blends. The step of Providing a Plurality of Pre-Blends 114 can include Acquiring Recipes 602, which can include accessing the database server 18 or otherwise accessing the recipes for a desirable pre-blend. In an example embodiment, the customized kibble blending system 10 can generate the recipes for desirable pre-blends. Step 114 can include Providing Components 604, which can include providing or acquiring any suitable component that can make up all or a portion of a pre-blend. Components can include macronutrients, micronutrients, supplements, water, energy, vitamins, minerals, spray on additives, coatings, cold compressed bits of supplements, tablets, liquids, generic kibbles, glucosamine, chondroitin, preservatives, probiotics, nutrients, or the like. In some cases, the components can be introduced via the pre-blended kibbles. In an example embodiment, the components can be sent to a blending center 26 such that the pre-blends can be created, however, it will be appreciated that the pre-blends can be created at any suitable location. Step 114 can include Ensuring Quality 606, which can include making sure the quality, freshness, sourcing, and processing of the components for the pre-blends is satisfactory. The step 114 can include Processing Pre-Blends 608, which can include creating the pre-blends from the plurality of components according to base formulas, recipes, and ratios and blends, and can include providing the necessary equipment to create the pre-blends. It will be appreciated that the method 100 may involve the blending of pre-fabricated or third party pre-blends where, for example, the blending center 26 can simply aggregate existing pre-blends. The method 100 may or may not include creating custom pre-blends from base components.

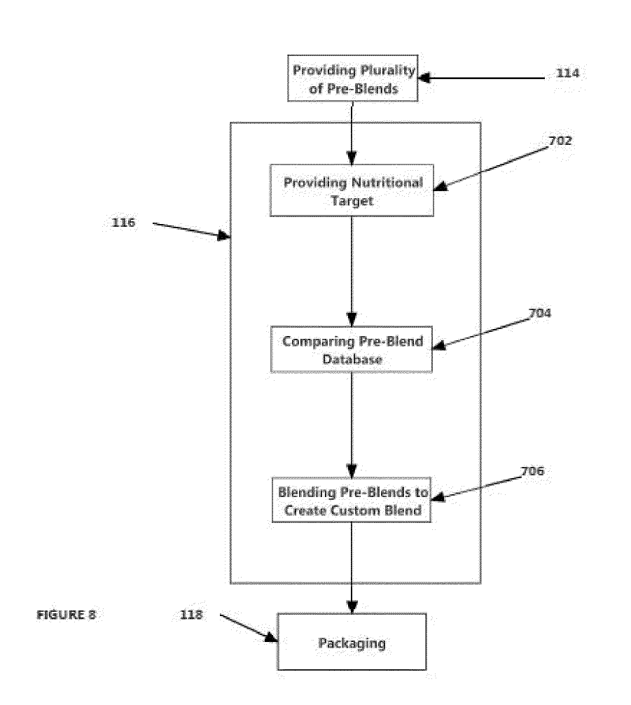

The method 100 can include Blending a Custom Blend 116. Providing a custom blend from one or a plurality of pre-blends can help to optimize a pet's diet and may be more cost efficient than creating a specific kibble for each pet on an individual basis. Although a generating a different formula from raw components for a pet may be impractical, the customized kibble blending system 10 can achieve the benefits of such a customized system with the efficiencies of pre-fabricated pre-blends that can be blended together to create desired results. The step of Blending a Custom Blend 116, with reference to FIG. 8, can include Providing a Nutritional Target 702 as described herein, Comparing the Pre-Blend Database 704 to the nutritional target, and Blending Pre-Blends to Create a Custom Blend 706. Step 706 can be performed, for example, at a blending center 26 or at any suitable location. The nutritional target can be ascertained, in one embodiment, just prior to the step of Blending Pre-Blends to Create a Custom Blend 706 such that the custom blend for the pet 13 is optimized to a real time or near real time profile 30 for the pet 13. The blended product can be an optimized formula of kibble, drawn from a broad range of pre-blends, that can be matched to a pet's immediate needs. Step 116 can also include creating the desired amount of product, which can be included in the profile 30 about a user 12. In an alternate embodiment, a user 12 can be sent pre-blends and can manually combine the pre-blends together at their home. This may be useful where an interaction between the pre-blends can advantageously occur shortly before consumption, such as in the combination of a liquid pre-blend with a dry kibble pre-blend. Any number of pre-blends can be used to create the custom blend, where using a lesser number of pre-blends to reach a desired nutritional target for a pet 13 may be beneficial. The number of pre-blends included in a blend can include one, from about one to about five, from about five to about ten, less than ten, more than ten, or any suitable number.

Upon creation of the customized blended product, the method 100 can transition to packaging 118. Packaging 118 can include providing a customized package for the blended kibble that is in accordance with the profile 30 of a user 12. Packaging 118 can occur at a packaging center 28 (FIG. 1) or at any other suitable location. Blended kibbles can be conveyed to a packaging apparatus for packaging in a container such as a plastic or plastic-lined paper bag, box, bottle or jar, which can provide protection during storage from moisture gain or loss, and infestation, and can also provide a way to identify and label the product. Packaging 118 can also include a printer which can print labels, such as self-adhesive labels, which can be affixed to the food container. The label, for example, can identify the individual pet for which the food was manufactured, the product formula, the product blend, ingredient list, date of manufacture, and the like. In an alternative embodiment, the profile 30 can include an electronic image of the individual pet 13 and can transmit the image to the server 16 and can generate a photo label of the pet for the food package, which can be printed by the printer on a label. Packaging 118 can also include producing printed material such as a package insert, a pamphlet or flyer having pet care information and instructions including, for example, a description of the customized pet food formula, pet food blend, feeding recommendations including specific recommendations regarding amount, and feeding methods, recommendations for treats and supplements, and recommendations on veterinary care. Such information can include website or profile 30 information where a user 12 can input or review detailed information regarding their pet 13. The packaging can be shaped, scented, colored, or designed in any suitable configuration, where the user 12 can select from various options in their profile 30. Packaging 118 can also include using a reusable container that can be returned by a consumer to reduce waste.

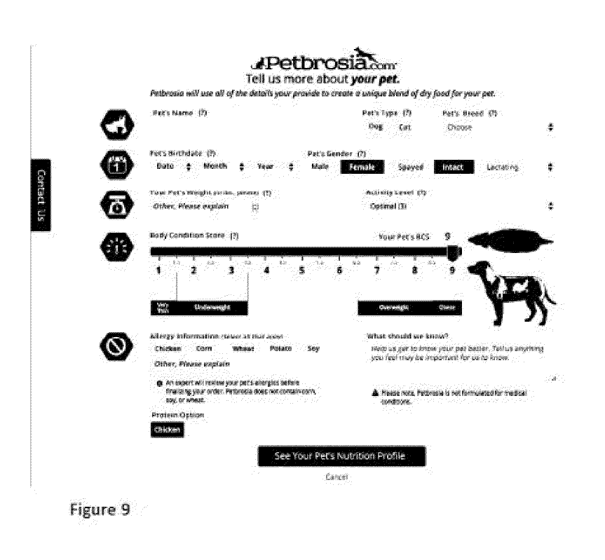

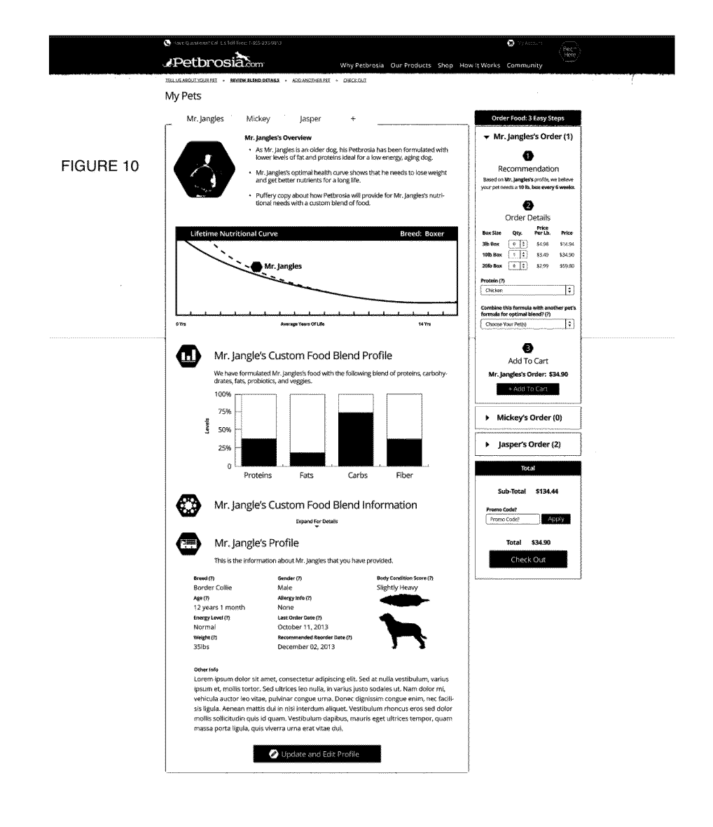

FIG. 9 shows an example screen shot illustrating various aspects of inputs for the customized kibble blending system 10. FIG. 10 shows an example screen shot illustrating various aspects of outputs for the customized kibble blending system 10. As is to be readily appreciated, the particular metrics, scores, rules, and so forth illustrated in FIGS. 9 and 10 are merely intended to be illustrative and not limiting. In fact, other embodiments may use different metrics, scores, inputs, and rules without departing from the scope of the present disclosure.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signal.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A method for providing a customized food blend for a pet, the method comprising:
creating a first environmental profile for the pet at a first time with a customized kibble blending system;
creating a nutritional target for the pet;
creating a pre-blend database;
providing a plurality of pre-blends;
determining a custom blend; and
blending a custom blend for the pet.

2. The method of claim 1, wherein creating the first environmental profile for the pet comprises;
inputting pet characteristics; and
inputting home characteristics.

3. The method of claim 2, wherein creating the first environmental profile further comprises;
inputting food preferences;
inputting shopping characteristics;
inputting relationship characteristics; and
inputting a daily diet for the pet.

4. The method of claim 1, wherein creating the nutritional target for the pet comprises;
providing the first environmental profile;
acquiring data, wherein the data includes published pet nutrition information;
comparing the data to the first environmental profile; and
generating the nutritional target from the data and the first environmental profile.

5. The method of claim 4, wherein creating the nutritional target for the pet further comprises;
providing a second environmental profile at a second time;
comparing the first environmental profile to the second environmental profile; and
wherein generating the nutritional target comprises evaluating the difference between the first environmental profile at the first time and the second environmental profile at the second time.

6. The method of claim 1, wherein providing the plurality of pre-blends comprises;
acquiring recipes;
acquiring components;
ensuring quality; and
processing pre-blends.

7. The method of claim 1, wherein blending the custom blend comprises;
providing the nutritional target;
comparing the pre-blend database to the nutritional target;
selecting a plurality of pre-blends from the pre-blend database;
determining the amount and ratio of the selected plurality of pre-blends; and
blending the plurality of pre-blends.

8. The method of claim 1, further comprising packaging the custom blend, wherein packaging the custom blend comprises customizing a package for the custom blend.

9. The method of claim 1, further comprising shipping the custom blend.

10. The method of claim 1, further comprising screening the first environmental profile.

11. The method of claim 10, wherein screening the first environmental profile comprises assisting a user in determining pet breed.

12. The method of claim 1, wherein the customized kibble blending system comprises a server, a database server, and an ecommerce server.

13. The method of claim 1, wherein the customized kibble blending system is configured to receive a plurality of inputs from a user.

14. The method of claim 1, wherein the customized kibble blending system comprises a sensor associated with the pet.

15. The method of claim 1, wherein the customized kibble blending system comprises a user interface that is configured to accept information about a user and the pet.

16. The method of claim 1, wherein providing a plurality of pre-blends comprises acquiring the plurality of pre-blends from a third party provider.

17. The method of claim 1, wherein determining the custom blend comprises evaluating additional food items given to the pet by a user.

18. A method for providing a customized food blend for a pet, the method comprising:
creating a first environmental profile for the pet at a first time with a customized kibble blend system, the customized kibble blending system including a custom blending computer system, wherein creating the first environmental profile comprises;
inputting pet characteristics, wherein the pet characteristics include age, breed, and weight;
inputting home characteristics;
inputting food preferences;
inputting shopping characteristics;
inputting relationship characteristics; and
inputting a daily diet for the pet;
creating a custom nutritional target for the pet, wherein creating the custom nutritional target for the pet comprises;
providing the first environmental profile;
acquiring data, wherein the data includes published pet nutrition information;
comparing the data to the first environmental profile; and
generating the nutritional target from the data and the first environmental profile;
creating a pre-blend database;
providing a plurality of pre-blends;
determining a custom blend; and
blending the custom blend for the pet, wherein blending the custom blend for the pet comprises;
providing the nutritional target;
comparing the pre-blend database to the nutritional target;
selecting a plurality of pre-blends from the pre-blend database;
determining the amount and ratio of each of the selected plurality of pre-blends; and
blending the plurality of pre-blends;
packaging the blend with a custom package; and
shipping the custom package.

19. A method for providing a customized food blend for a pet, the method comprising:
a step for creating an environmental profile;
a step for creating a nutritional target;
a step for creating a pre-blend database; and
a step for creating a custom blend from the pre-blend database.

20. The method of claim 19, further comprising a step for packaging the custom blend and a step for shipping the custom blend.
